(19) United States
(12) Patent Application Publication
(10) Pub. No.: US 2025/0265701 A1
(43) Pub. Date: Aug. 21, 2025

(54) TRANSIENT DEFECT INSPECTION USING AN INSPECTION IMAGE

(71) Applicant: ASML Netherlands B.V., Veldhoven (NL)

(72) Inventors: Shengcheng JIN, San Jose, CA (US); Datong ZHANG, San Jose, CA (US); Xuechen ZHU, San Jose, CA (US); Chih-Yu JEN, San Jose, CA (US); Liang TANG, San Jose, CA (US); Hsiang Ting YEH, San Jose, CA (US)

(73) Assignee: ASML Netherlands B.V., Veldhoven (NL)

(21) Appl. No.: 18/859,466

(22) PCT Filed: Jul. 6, 2023
(86) PCT No.: PCT/EP2023/068637

§ 371 Date: Oct. 23, 2024

Related U.S. Application Data
(60) Provisional application No. 63/368,601, filed on Jul. 15, 2022.

(51) Int. Cl. G06T 7/00; G06T 5/50

(52) U.S. Cl. CPC G06T 7/001; G06T 5/50; G06T 2207/10016; G06T 2207/10061; G06T 2207/20216; G06T 2207/30148

(57) ABSTRACT

An improved method and system for transient defect inspection using an inspection image are disclosed. The method comprises acquiring a plurality of inspection images, generating an average image of the plurality of inspection images, detecting a first type defect in the average image, determining a mask area corresponding to the first type defect, and determining whether the plurality of inspection images have a second type defect in a non-masked area.

### CROSS-REFERENCE TO RELATED APPLICATIONS

This application claims priority of U.S. application 63/368,601 which was filed on 15 Jul. 2022 and which is incorporated herein in its entirety by reference.

### TECHNICAL FIELD

The embodiments provided herein relate to a transient defect inspection technology, and more particularly to a transient defect inspection technology using an inspection image.

### BACKGROUND

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes, such as a scanning electron microscope (SEM) can be employed. As the physical sizes of IC components continue to shrink, defect detection accuracy becomes more important. Inspection images such as SEM images can be used to identify or classify a defect(s) of the manufactured ICs. To improve defect detection performance, methods and systems that can more accurately detect transient defects as well as hard defects are desired.

### SUMMARY

The embodiments provided herein disclose an inspection apparatus, and more particularly, a transient defect inspection technology using an inspection image by an inspection apparatus.

Some embodiments provide an apparatus for transient defect inspection using an inspection image. The apparatus comprises a memory storing a set of instructions; and at least one processor configured to execute the set of instructions to cause the apparatus to perform: acquiring a plurality of inspection images; generating an average image of the plurality of inspection images; detecting a first type defect in the average image; determining a mask area corresponding to the first type defect; and determining whether the plurality of inspection images have a second type defect in a non-masked area.

Some embodiments provide an apparatus for transient defect inspection using an inspection image. The apparatus comprises a memory storing a set of instructions; and at least one processor configured to execute the set of instructions to cause the apparatus to perform: acquiring a plurality of inspection images; generating an average image of the plurality of inspection images; detecting a first type defect in the average image; determining a mask area corresponding to the first type defect; comparing individual inspection images of the plurality of inspection images to the average image for a non-masked area; and determining whether the plurality of inspection images have a second type defect in the non-masked area based on the comparison.

Other advantages of the embodiments of the present disclosure will become apparent from the following description taken in conjunction with the accompanying drawings wherein are set forth, by way of illustration and example, certain embodiments of the present invention.

### BRIEF DESCRIPTION OF FIGURES

The above and other aspects of the present disclosure will become more apparent from the description of exemplary embodiments, taken in conjunction with the accompanying drawings.

FIG. 1 is a schematic diagram illustrating an example charged-particle beam inspection system, consistent with embodiments of the present disclosure.

FIG. 2 is a schematic diagram illustrating an example multi-beam tool that can be a part of the example charged-particle beam inspection system of FIG. 1, consistent with embodiments of the present disclosure.

FIG. 3 is an example diagram illustrating characteristics of a transient defect, consistent with embodiments of the present disclosure.

FIG. 4 is a block diagram of an example transient defect detection system, consistent with embodiments of the present disclosure.

FIG. 5A illustrates a plurality of inspection images, consistent with embodiments of the present disclosure.

FIG. 5B illustrates an average image of the plurality of inspection images of FIG. 5A and a detected first type defect from the average image, consistent with embodiments of the present disclosure.

FIG. 5C illustrates a mask generated based on a detected first type defect, consistent with embodiments of the present disclosure.

FIG. 6A illustrates a first algorithm for detecting a second type defect, consistent with embodiments of the present disclosure.

FIG. 6B illustrates a second algorithm for detecting a second type defect, consistent with embodiments of the present disclosure.

FIG. 7A illustrates a detected second type defect, consistent with embodiments of the present disclosure.

FIG. 7B illustrates combined first and second type defects, consistent with embodiments of the present disclosure.

FIG. 8 is a process flowchart representing an exemplary transient defect detection method, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with aspects related to the disclosed embodiments as recited in the appended claims. For example, although some embodiments are described in the context of utilizing electron beams, the disclosure is not so limited. Other types of charged particle beams may be similarly applied. Furthermore, other imaging systems may be used, such as optical imaging, photo detection, x-ray detection, etc.

Electronic devices are constructed of circuits formed on a piece of semiconductor material called a substrate. The semiconductor material may include, for example, silicon, gallium arsenide, indium phosphide, or silicon germanium, or the like. Many circuits may be formed together on the same piece of silicon and are called integrated circuits or ICs. The size of these circuits has decreased dramatically so that many more of them can be fit on the substrate. For example, an IC chip in a smartphone can be as small as a thumbnail and yet may include over 2 billion transistors, the size of each transistor being less than 1/1000th the size of a human hair.

Making these ICs with extremely small structures or components is a complex, time-consuming, and expensive process, often involving hundreds of individual steps. Errors in even one step have the potential to result in defects in the finished IC, rendering it useless. Thus, one goal of the manufacturing process is to avoid such defects to maximize the number of functional ICs made in the process; that is, to improve the overall yield of the process.

One component of improving yield is monitoring the chip-making process to ensure that it is producing a sufficient number of functional integrated circuits. One way to monitor the process is to inspect the chip circuit structures at various stages of their formation. Inspection can be carried out using a scanning charged-particle microscope (SCPM). For example, an SCPM may be a scanning electron microscope (SEM). A SCPM can be used to image these extremely small structures, in effect, taking a “picture” of the structures of the wafer. The image can be used to determine if the structure was formed properly in the proper location. If the structure is defective, then the process can be adjusted, so the defect is less likely to recur.

As the physical sizes of IC components continue to shrink, accuracy and yield in defect detection become more important. Inspection images such as SCPM images can be used to identify or classify a defect(s) of the manufactured ICs. The SCPM image has noise as well as structure information of a wafer. Because the noise in the SCPM image makes it difficult to detect or identify defects from the SCPM image, frame averaging can be employed to obtain a cleaner SCPM image with less noise and to detect defects therefrom. In frame averaging, multiple SCPM images of a single imaging area of a wafer (e.g., a single die) are taken over a time sequence, and an average image of the multiple SCPM images is utilized in detecting defects. Because noise of an SCPM image is random, a noise level can be lowered by averaging multiple SCPM images. Therefore, defect detection accuracy can be improved. However, while hard defects that appear repetitively on multiple SCPM images can effectively be detected from an average image with less noise, transient defects that do not consistently appear on SCPM images may not be detected from the average image. Therefore, methods and systems that can more accurately detect transient defects are desired.

Embodiments of the disclosure may provide an improved transient defect inspection technique. According to some embodiments of the present disclosure, a technique can detect both transient defects and hard defects. According to some embodiments of the present disclosure, defect detection performance and the overall efficiency of the system can be improved by excluding the regions containing already identified defects in transient defect inspection. According to some embodiments of the present disclosure, a nuisance rate can be lowered when detecting transient defects by using an average image as a reference image.

Relative dimensions of components in drawings may be exaggerated for clarity. Within the following description of drawings, the same or like reference numbers refer to the same or like components or entities, and only the differences with respect to the individual embodiments are described. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

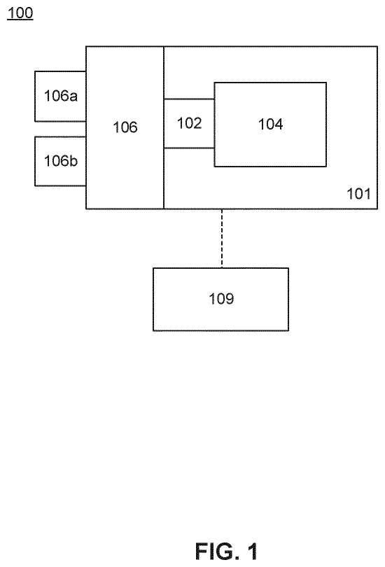

FIG. 1 illustrates an example electron beam inspection (EBI) system 100 consistent with embodiments of the present disclosure. EBI system 100 may be used for imaging. As shown in FIG. 1, EBI system 100 includes a main chamber 101, a load/lock chamber 102, a beam tool 104, and an equipment front end module (EFEM) 106. Beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by beam tool 104. Beam tool 104 may be a single-beam system or a multi-beam system.

A controller 109 is electronically connected to beam tool 104. Controller 109 may be a computer configured to execute various controls of EBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (or “apps”) for specific tasks. The memory may also be a virtual memory that includes one or more memories distributed across multiple machines or devices coupled via a network.

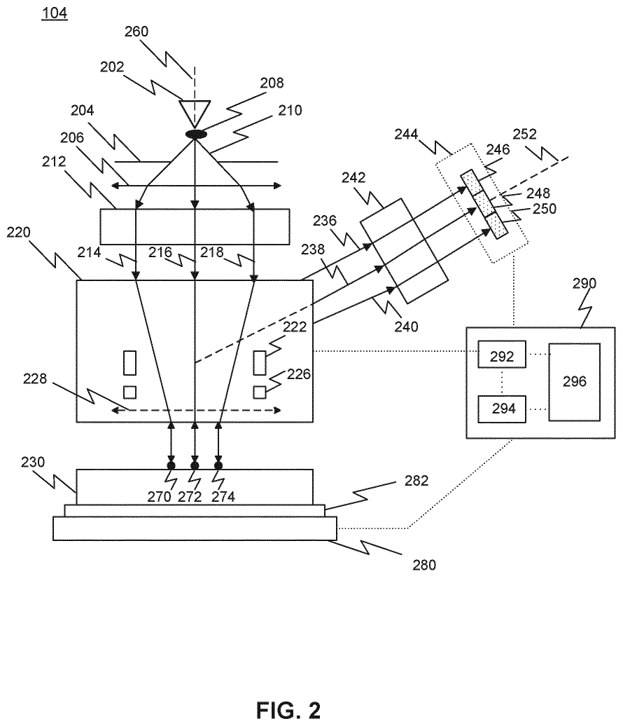

FIG. 2 illustrates a schematic diagram of an example multi-beam tool 104 (also referred to herein as apparatus 104) and an image processing system 290 that may be configured for use in EBI system 100 (FIG. 1), consistent with embodiments of the present disclosure.

Beam tool 104 comprises a charged-particle source 202, a gun aperture 204, a condenser lens 206, a primary charged-particle beam 210 emitted from charged-particle source 202, a source conversion unit 212, a plurality of beamlets 214, 216, and 218 of primary charged-particle beam 210, a primary projection optical system 220, a motorized wafer stage 280, a wafer holder 282, multiple secondary charged-particle beams 236, 238, and 240, a secondary optical system 242, and a charged-particle detection device 244. Primary projection optical system 220 can comprise a beam separator 222, a deflection scanning unit 226, and an objective lens 228. Charged-particle detection device 244 can comprise detection sub-regions 246, 248, and 250.

Charged-particle source 202, gun aperture 204, condenser lens 206, source conversion unit 212, beam separator 222, deflection scanning unit 226, and objective lens 228 can be aligned with a primary optical axis 260 of apparatus 104. Secondary optical system 242 and charged-particle detection device 244 can be aligned with a secondary optical axis 252 of apparatus 104.

Charged-particle source 202 can emit one or more charged particles, such as electrons, protons, ions, muons, or any other particle carrying electric charges. In some embodiments, charged-particle source 202 may be an electron source. For example, charged-particle source 202 may include a cathode, an extractor, or an anode, wherein primary electrons can be emitted from the cathode and extracted or accelerated to form primary charged-particle beam 210 (in this case, a primary electron beam) with a crossover (virtual or real) 208. For ease of explanation without causing ambiguity, electrons are used as examples in some of the descriptions herein. However, it should be noted that any charged particle may be used in any embodiment of this disclosure, not limited to electrons. Primary charged-particle beam 210 can be visualized as being emitted from crossover 208. Gun aperture 204 can block off peripheral charged particles of primary charged-particle beam 210 to reduce Coulomb effect. The Coulomb effect may cause an increase in size of probe spots.

Source conversion unit 212 can comprise an array of image-forming elements and an array of beam-limit apertures. The array of image-forming elements can comprise an array of micro-deflectors or micro-lenses. The array of image-forming elements can form a plurality of parallel images (virtual or real) of crossover 208 with a plurality of beamlets 214, 216, and 218 of primary charged-particle beam 210. The array of beam-limit apertures can limit the plurality of beamlets 214, 216, and 218. While three beamlets 214, 216, and 218 are shown in FIG. 2, embodiments of the present disclosure are not so limited. For example, in some embodiments, the apparatus 104 may be configured to generate a first number of beamlets. In some embodiments, the first number of beamlets may be in a range from 1 to 1000. In some embodiments, the first number of beamlets may be in a range from 200-500. In an exemplary embodiment, an apparatus 104 may generate 400 beamlets.

Condenser lens 206 can focus primary charged-particle beam 210. The electric currents of beamlets 214, 216, and 218 downstream of source conversion unit 212 can be varied by adjusting the focusing power of condenser lens 206 or by changing the radial sizes of the corresponding beam-limit apertures within the array of beam-limit apertures. Objective lens 228 can focus beamlets 214, 216, and 218 onto a wafer 230 for imaging, and can form a plurality of probe spots 270, 272, and 274 on a surface of wafer 230.

Beam separator 222 can be a beam separator of Wien filter type generating an electrostatic dipole field and a magnetic dipole field. In some embodiments, if they are applied, the force exerted by the electrostatic dipole field on a charged particle (e.g., an electron) of beamlets 214, 216, and 218 can be substantially equal in magnitude and opposite in a direction to the force exerted on the charged particle by magnetic dipole field. Beamlets 214, 216, and 218 can, therefore, pass straight through beam separator 222 with zero deflection angle. However, the total dispersion of beamlets 214, 216, and 218 generated by beam separator 222 can also be non-zero. Beam separator 222 can separate secondary charged-particle beams 236, 238, and 240 from beamlets 214, 216, and 218 and direct secondary charged-particle beams 236, 238, and 240 towards secondary optical system 242.

Deflection scanning unit 226 can deflect beamlets 214, 216, and 218 to scan probe spots 270, 272, and 274 over a surface area of wafer 230. In response to the incidence of beamlets 214, 216, and 218 at probe spots 270, 272, and 274, secondary charged-particle beams 236, 238, and 240 may be emitted from wafer 230. Secondary charged-particle beams 236, 238, and 240 may comprise charged particles (e.g., electrons) with a distribution of energies. For example, secondary charged-particle beams 236, 238, and 240 may be secondary electron beams including secondary electrons (energies≤ 50 eV) and backscattered electrons (energies between 50 eV and landing energies of beamlets 214, 216, and 218). Secondary optical system 242 can focus secondary charged-particle beams 236, 238, and 240 onto detection sub-regions 246, 248, and 250 of charged-particle detection device 244. Detection sub-regions 246, 248, and 250 may be configured to detect corresponding secondary charged-particle beams 236, 238, and 240 and generate corresponding signals (e.g., voltage, current, or the like) used to reconstruct an inspection image of structures on or underneath the surface area of wafer 230.

The generated signals may represent intensities of secondary charged-particle beams 236, 238, and 240 and may be provided to image processing system 290 that is in communication with charged-particle detection device 244, primary projection optical system 220, and motorized wafer stage 280. The movement speed of motorized wafer stage 280 may be synchronized and coordinated with the beam deflections controlled by deflection scanning unit 226, such that the movement of the scan probe spots (e.g., scan probe spots 270, 272, and 274) may orderly cover regions of interests on the wafer 230. The parameters of such synchronization and coordination may be adjusted to adapt to different materials of wafer 230. For example, different materials of wafer 230 may have different resistance-capacitance characteristics that may cause different signal sensitivities to the movement of the scan probe spots.

The intensity of secondary charged-particle beams 236, 238, and 240 may vary according to the external or internal structure of wafer 230, and thus may indicate whether wafer 230 includes defects. Moreover, as discussed above, beamlets 214, 216, and 218 may be projected onto different locations of the top surface of wafer 230, or different sides of local structures of wafer 230, to generate secondary charged-particle beams 236, 238, and 240 that may have different intensities. Therefore, by mapping the intensity of secondary charged-particle beams 236, 238, and 240 with the areas of wafer 230, image processing system 290 may reconstruct an image that reflects the characteristics of internal or external structures of wafer 230.

In some embodiments, image processing system 290 may include an image acquirer 292, a storage 294, and a controller 296. Image acquirer 292 may comprise one or more processors. For example, image acquirer 292 may comprise a computer, server, mainframe host, terminals, personal computer, any kind of mobile computing devices, or the like, or a combination thereof. Image acquirer 292 may be communicatively coupled to charged-particle detection device 244 of beam tool 104 through a medium such as an electric conductor, optical fiber cable, portable storage media, IR, Bluetooth, internet, wireless network, wireless radio, or a combination thereof. In some embodiments, image acquirer 292 may receive a signal from charged-particle detection device 244 and may construct an image. Image acquirer 292 may thus acquire inspection images of wafer 230. Image acquirer 292 may also perform various post-processing functions, such as generating contours, superimposing indicators on an acquired image, or the like. Image acquirer 292 may be configured to perform adjustments of brightness and contrast of acquired images. In some embodiments, storage 294 may be a storage medium such as a hard disk, flash drive, cloud storage, random access memory (RAM), other types of computer-readable memory, or the like. Storage 294 may be coupled with image acquirer 292 and may be used for saving scanned raw image data as original images, and post-processed images. Image acquirer 292 and storage 294 may be connected to controller 296. In some embodiments, image acquirer 292, storage 294, and controller 296 may be integrated together as one control unit.

In some embodiments, image acquirer 292 may acquire one or more inspection images of a wafer based on an imaging signal received from charged-particle detection device 244. An imaging signal may correspond to a scanning operation for conducting charged particle imaging. An acquired image may be a single image comprising a plurality of imaging areas. The single image may be stored in storage 294. The single image may be an original image that may be divided into a plurality of regions. Each of the regions may comprise one imaging area containing a feature of wafer 230. The acquired images may comprise multiple images of a single imaging area of wafer 230 sampled multiple times over a time sequence. The multiple images may be stored in storage 294. In some embodiments, image processing system 290 may be configured to perform image processing steps with the multiple images of the same location of wafer 230.

In some embodiments, image processing system 290 may include measurement circuits (e.g., analog-to-digital converters) to obtain a distribution of the detected secondary charged particles (e.g., secondary electrons). The charged-particle distribution data collected during a detection time window, in combination with corresponding scan path data of beamlets 214, 216, and 218 incident on the wafer surface, can be used to reconstruct images of the wafer structures under inspection. The reconstructed images can be used to reveal various features of the internal or external structures of wafer 230, and thereby can be used to reveal any defects that may exist in the wafer.

In some embodiments, the charged particles may be electrons. When electrons of primary charged-particle beam 210 are projected onto a surface of wafer 230 (e.g., probe spots 270, 272, and 274), the electrons of primary charged-particle beam 210 may penetrate the surface of wafer 230 for a certain depth, interacting with particles of wafer 230. Some electrons of primary charged-particle beam 210 may elastically interact with (e.g., in the form of elastic scattering or collision) the materials of wafer 230 and may be reflected or recoiled out of the surface of wafer 230. An elastic interaction conserves the total kinetic energies of the bodies (e.g., electrons of primary charged-particle beam 210) of the interaction, in which the kinetic energy of the interacting bodies does not convert to other forms of energy (e.g., heat, electromagnetic energy, or the like). Such reflected electrons generated from elastic interaction may be referred to as backscattered electrons (BSEs). Some electrons of primary charged-particle beam 210 may inelastically interact with (e.g., in the form of inelastic scattering or collision) the materials of wafer 230. An inelastic interaction does not conserve the total kinetic energies of the bodies of the interaction, in which some or all of the kinetic energy of the interacting bodies convert to other forms of energy. For example, through the inelastic interaction, the kinetic energy of some electrons of primary charged-particle beam 210 may cause electron excitation and transition of atoms of the materials. Such inelastic interaction may also generate electrons exiting the surface of wafer 230, which may be referred to as secondary electrons (SEs). Yield or emission rates of BSEs and SEs depend on, e.g., the material under inspection and the landing energy of the electrons of primary charged-particle beam 210 landing on the surface of the material, among others. The energy of the electrons of primary charged-particle beam 210 may be imparted in part by its acceleration voltage (e.g., the acceleration voltage between the anode and cathode of charged-particle source 202 in FIG. 2). The quantity of BSEs and SEs may be more or fewer (or even the same) than the injected electrons of primary charged-particle beam 210.

The images generated by SCPM may be used for defect inspection. For example, a generated image capturing a test device region of a wafer may be compared with a reference image capturing the same test device region. The reference image may be predetermined (e.g., by simulation) and include no known defect. If a difference between the generated image and the reference image exceeds a tolerance level, a potential defect may be identified. For another example, the SCPM may scan multiple regions of the wafer, each region including a test device region designed as the same, and generate multiple images capturing those test device regions as manufactured. The multiple images may be compared with each other. If a difference between the multiple images exceeds a tolerance level, a potential defect may be identified.

The SCPM image has noise as well as structure information of a test device region of a wafer. Because the noise in the SCPM image makes it difficult to detect or identify defects from the SCPM image, frame averaging can be employed to obtain a cleaner SCPM image with less noise and to detect defects therefrom. In frame averaging, multiple SCPM images of a single imaging area of a wafer (e.g., a single die) are taken over a time sequence, and an average image of the multiple SCPM images is utilized in detecting defects. Because noise of an SCPM image is random, a noise level can be lowered by averaging multiple SCPM images. Therefore, defect detection accuracy can be improved. However, while defects that appear repetitively on multiple SCPM images can effectively be detected from an average image with less noise, some defects that do not consistently appear on SCPM images may not be detected from the average image. Such defects that intermittently appear on SCPM images are called transient defects and defects that repeats on SCPM images are called hard defects in the present disclosure. In some instances, transient defects can occur because electrical characteristics of a defective structure, particularly a defective thin device structure, may change over time. For example, even if a defect actually exists in the wafer under inspection, due to such a time-dependent behavior of a thin device structure, sometimes the defect may not be captured by one SCPM image but may be captured by another SCPM image.

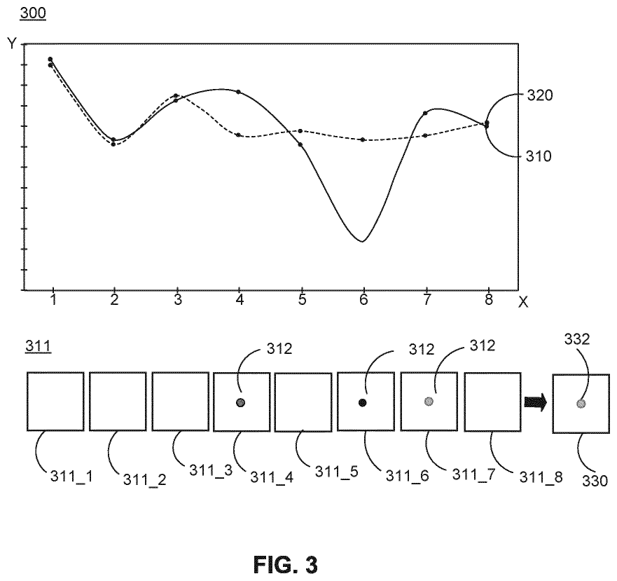

FIG. 3 is an example diagram illustrating characteristics of a transient defect, consistent with embodiments of the present disclosure. FIG. 3 illustrates a graph 300 showing a grey level of a SCPM image and a reference image at a certain location for each frame. In graph 300, an X-axis represents a frame number and a Y-axis represents a grey level. In graph 300, a line 310 represents a grey level of a SCPM image for each frame and a line 320 represents a grey level of a reference image for each frame. As shown in graph 300, a grey level of a SCPM image is almost equal to a corresponding grey level of a reference image in first to third, fifth, and eighth frames while a grey level of a SCPM image is different from a corresponding grey level of a reference image in fourth, sixth, and seventh frames. It is noted from graph 300 that a defect appears only on some SCPM images (e.g., in fourth, sixth, and seventh frames) among eight SCPM images and the defect can be called a transient defect.

FIG. 3 further illustrates first to eighth SCPM images 311_1 to 311_8 corresponding to first to eighth frames in graph 300 at the bottom. Consistent with graph 300, defect 312 appears only on fourth SCPM image 311_4, sixth SCPM image 311_6, and seventh SCPM image 311_7 and do not on first to third SCPM images 311_1 to 311_3, fifth SCPM image 311_5, and eighth SCPM image 311_8. When averaging eight SCPM images 311_1 to 311_8 in eight frames to generate an average image 330, grey level differences between a SCPM image and a reference image in fourth, sixth, and seventh frames are averaged out, and therefore the grey level difference may not be distinctive in average image 330. It is shown at the bottom of FIG. 3 that defect 332 corresponding to defect 312 is not distinctive on average image 330 because defect 312 on fourth, sixth, and seventh SCPM images 311_4, 311_6, and 311_7 is averaged out in average image 330. Because a transient defect cannot effectively be detected using frame averaging as discussed above referring to FIG. 3, methods and systems that can more accurately detect transient defects are desired.

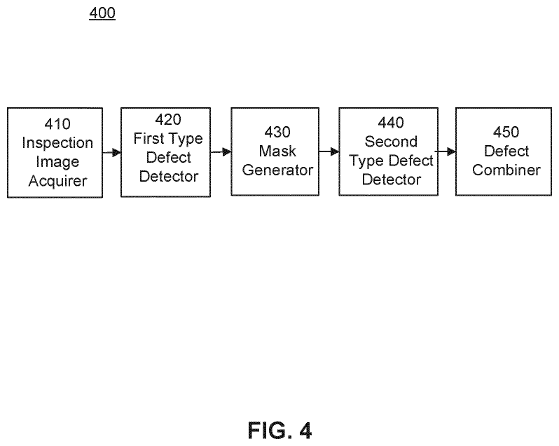

Reference is now made to FIG. 4, which is a block diagram of an example transient defect detection system, consistent with embodiments of the present disclosure. In some embodiments, a transient defect detection system 400 can comprise one or more processors and memories. It is appreciated that in various embodiments transient defect detection system 400 may be part of or may be separate from a charged-particle beam inspection system (e.g., EBI system 100 of FIG. 1). In some embodiments, transient defect detection system 400 may include one or more components (e.g., software modules) that can be implemented in controller 109 as discussed herein. As shown in FIG. 4, transient defect detection system 400 may comprise an inspection image acquirer 410, a first type defect detector 420, a mask generator 430, a second type defect detector 440, and a defect combiner 450.

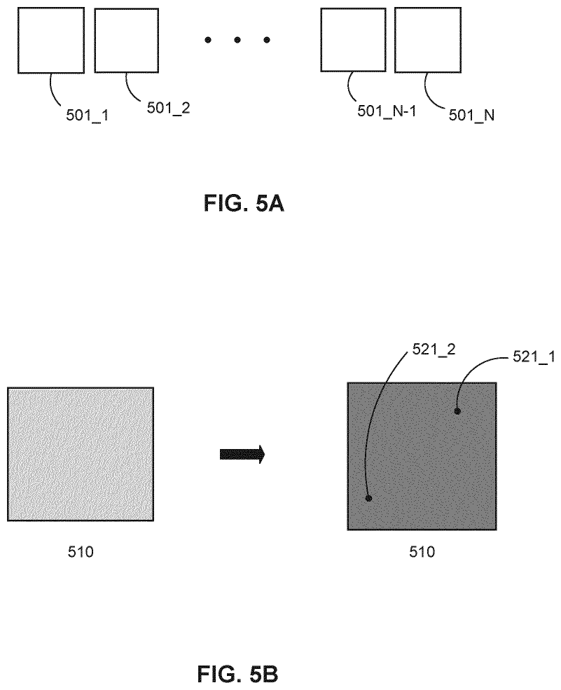

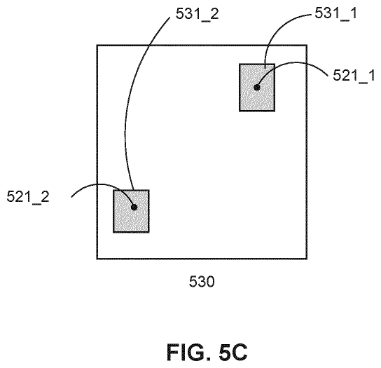

According to some embodiments of the present disclosure, inspection image acquirer 410 can acquire a plurality of inspection images. In some embodiments, an inspection image is a SCPM image of a sample or a wafer. In some embodiments, an inspection image can be an inspection image generated by, e.g., EBI system 100 of FIG. 1 or electron beam tool 104 of FIG. 2. In some embodiments, inspection image acquirer 410 may obtain an inspection image from a storage device or system storing the inspection image. FIG. 5A illustrates a plurality of inspection images 501_1 to 501_N of a region of a wafer, e.g., a single image area or a die of the wafer. In some embodiments, the plurality of inspection images 501_1 to 501_N are taken over a certain time period. In some embodiments, the plurality of inspection images 501_1 to 501_N are taken over a time sequence.

Referring back to FIG. 4, first type defect detector 420 can detect first type defects from the plurality of inspection images 501_1 to 501_N acquired by inspection image acquirer 410. In some embodiments of the present disclosure, first type defect detector 420 can obtain an average image of the plurality of inspection images 501_1 to 501_N. FIG. 5B shows an average image 510 of the plurality of inspection images 501_1 to 501_N. In some embodiments, average image 510 can be obtained by averaging the plurality of inspection images 501_1 to 501_N per pixel. For example, a pixel value of average image 510 at a certain location can be obtained by adding up each pixel value (e.g., grey level value) at a corresponding relative location on the plurality of inspection images 501_1 to 501_N and by dividing the sum with the number (i.e., N) of the plurality of inspection images 501_1 to 501_N.

According to some embodiments of the present disclosure, first type defect detector 420 can detect first type defects from average image 510. In some embodiments, first type defects can be detected by comparing average image 510 with a reference image. For example, average image 510 capturing a region of a wafer may be compared with a reference image capturing the region. The reference image may be predetermined (e.g., by simulation) and include no known defects. For another example, the reference image can be a SCPM image capturing a different region of the wafer or another wafer that is designed to have the same pattern as the region captured by the plurality of inspection images 501_1 to 501_N. In some embodiments, the reference image can be an average image of multiple SCPM images capturing a different region of the wafer or another wafer that is designed to have the same pattern as the region captured by the plurality of inspection images 501_1 to 501_N.

For another example, average image 510 itself can be a reference image to detect first type defects from average image 510. When average image 510 has periodic patterns, a certain portion of average image 510 can be compared to another portion of average image 510 having the same pattern as the certain portion.

In some embodiments, a difference image between average image 510 and the reference image can be obtained based on comparison. In some embodiments, a pixel value of average image 510 can be compared to a pixel value of the reference image at the same relative location on a corresponding image. Pixel values of the difference image at locations that do not include defects can be nearly or close to zero. In some embodiments, if a difference between average image 510 and the reference image exceeds a predetermined threshold value, a potential defect (i.e., potential first defect) may be identified. In some embodiments, the threshold value can be determined based on noise levels of average image 510 and the reference image, defect detection sensitivity, etc. In some embodiments, a post process to identified potential defects can be performed to remove nuisance defects, classify defects, etc.

In FIG. 5B, two detected first type defects 521_1 and 521_2 are shown on average image 510 at corresponding locations. In some embodiments, when a plurality of pixels that are in close proximity to each other are determined to have abnormal pixel values, it can be determined that the plurality of pixels can constitute a single first type defect. Accordingly, in some embodiments, a single first type defect (e.g., first type defect 521_1 or 521_2) can consist of multiple pixels. In some embodiments, first type defects 521_1 and 521_2 can refer to potential defects that may need a post process to remove nuisance defects, classify defects, etc. While detected first type defects 521_1 and 521_2 are illustrated on average image 510 in FIG. 5B, it will be appreciated that first type defects can be provided as a defect list including a defect identification, a defect location on an inspection image, a defect type, etc.

Referring back to FIG. 4, mask generator 430 can generate a mask 530 including mask area(s) corresponding to first type defects detected by first type defect detector 420. As shown in FIG. 5C, mask 530 can include mask areas corresponding to detected first type defects. For example, first mask area 531_1 corresponds to first type defect 521_1 and second mask area 531_2 corresponds to second type defect 521_1. In some embodiments, a location and a size of mask area 531_1 or 531_2 can be determined to cover a region containing a corresponding first type defect 521_1 or 521_2. In some embodiments, a size of mask area 531_1 or 531_2 can be determined to be larger than a size of first type defect 521_1 or 521_2 so to embrace boundaries of first type defect 521_1 or 521_2.

Referring back to FIG. 4, second type defect detector 440 can detect second type defect from a plurality of inspection images acquired by inspection image acquirer 410. According to some embodiments of the present disclosure, second type defect detector 440 can mask the plurality of inspection images 501_1 to 501_N with mask 530 generated by mask generator 430, and detect second type defect for non-masked areas of the plurality of inspection images 501_1 to 501_N. According to some embodiments of the present disclosure, the regions containing first type defects 521_1 and 521_2 that are already identified by first type defect detector 420 are excluded in detecting second type defects. Because grey levels around a defect are generally not stable and the defect boundary is irregular, defect detection on the defect regions may cost considerable computation time and computational resources. Therefore, excluding the regions containing already detected defects when detecting second type defects can improve defect detection performance and the overall efficiency of the system.

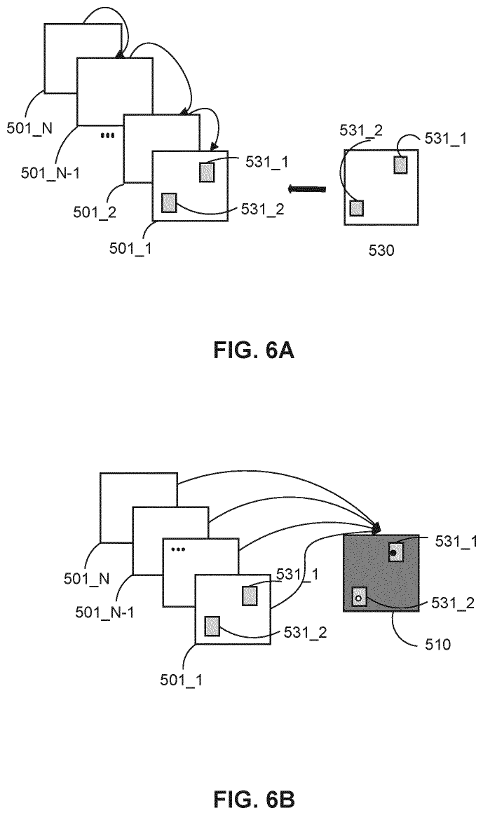

FIG. 6A illustrates a first algorithm for detecting a second type defect, consistent with embodiments of the present disclosure. As shown in FIG. 6A, the plurality of inspection images 501_1 to 501_N are masked with mask 530 having mask areas 531_1 and 531_2 generated by mask generator 430. According to some embodiments of the present disclosure, second type defect detector 440 can detect second type defect(s) by comparing the plurality of inspection images 501_1 to 501_N each other. In some embodiments, any two individual masked inspection images among the plurality of inspection images 501_1 to 501_N can be compared with each other to detect second type defects. For example, as shown in FIG. 6A, first inspection image 501_1 can be compared to second inspection image 501_2 and similarly any inspection image can be compared to a neighboring or any other inspection image. According to some embodiments of the present disclosure, a comparison between any two inspection images can be performed only for non-masked areas. For example, first inspection image 501_1 and second inspection image 501_2 can be compared with each other for areas other than mask areas 531_1 and 531_2.

In some embodiments, a difference image between two masked images (e.g., first inspection image 501_1 and second inspection image 501_2) can be obtained for non-masked areas based on comparison. In some embodiments, a pixel value of first inspection image 501_1 can be compared to a pixel value of second inspection image 501_2 at the same relative location on a corresponding image. Pixel values of the difference image at locations that do not include defects can be nearly or close to zero. In some embodiments, if a difference between first inspection image 501_1 and second inspection image 501_2 exceeds a predetermined threshold value, a potential defect, i.e., potential second defect may be identified. In some embodiments, the threshold value can be determined based on noise levels of first inspection image 501_1 and second inspection image 501_2, defect detection sensitivity, etc. In some embodiments, a post process to identified potential defects can be performed to remove nuisance defects, classify defects, etc. While a first algorithm for detecting second type defects has been illustrated based on a comparison between first inspection image 501_1 and second inspection image 501_2, it will be appreciated that any two or more inspection images among the plurality of inspection images 501_1 to 501_N can be utilized to detect second type defects.

According to a first algorithm, defect detection performance can be improved by excluding the regions containing already detected defects when detecting second type defects. However, it might be difficult to detect defects by comparing individual inspection images when individual inspection images are noisy. In particular, a nuisance rate can become higher when detecting defects by comparing two noisy images. This could get worse if a threshold value for determining a defect is lowered to detect a weak defect. Further, it is difficult to distinguish permanent breakdowns from temporary breakdowns by comparing individual inspection images. In the present disclosure, a breakdown can mean a sudden change of device electrical characteristics, which may change an inspection signal corresponding to the area of the device having the breakdown. Once a breakdown occurs, a defective device, which has been generating a constant inspection signal indicating a defect of the device, may not generate the inspection signal indicating the defect (i.e., the defective device may generate a different inspection signal from the original inspection signal indicating the defect) in the following frames. While a permanent breakdown has a permanent effect, i.e., the original inspection signal may not come back once the permanent breakdown occurs, a temporary breakdown's effect lasts only for a certain period. In some instances, a temporary breakdown may show a periodic behavior. For example, the temporary breakdown may disappear after several frames, then the device may restart from an initial state, and the temporary breakdown shows up again. To properly address or resolve breakdown issues, it is important to identify which breakdown it is, e.g., a permanent breakdown or a temporary breakdown. However, comparing individual inspection images may not effectively distinguish a permanent breakdown and a temporary breakdown.

FIG. 6B illustrates a second algorithm for detecting a second type defect, consistent with embodiments of the present disclosure. As shown in FIG. 6B, the plurality of inspection images 501_1 to 501_N are masked with mask (e.g., mask 530 having mask areas 531_1 and 531_2 of FIG. 5C) generated by mask generator 430. In some embodiments, average image 510 of the plurality of inspection images 501_1 to 501_N can also be masked with mask 530. According to some embodiments of the present disclosure, second type defect detector 440 can detect second type defects by comparing any individual masked inspection image from the plurality of inspection images 501_1 to 501_N with average image 510. For example, as shown in FIG. 6B, each inspection image 501_1 to 501_N can be compared to average image 510. According to some embodiments of the present disclosure, a comparison between inspection image 501_1 to 501_N and average image 510 can be performed only for non-masked areas. For example, first inspection image 501_1 and average image 510 can be compared with each other for areas other than mask areas 531_1 and 531_2.

In some embodiments, a difference image between inspection image 501_1 to 501_N and average image 510 can be obtained for non-masked areas based on the comparison. In some embodiments, a pixel value of first inspection image 501_1 can be compared to a pixel value of average image 510 at the same relative location on a corresponding image. In some embodiments, if a difference between first inspection image 501_1 and average image 510 exceeds a predetermined threshold value, a potential defect (i.e., potential second defect) may be identified. In some embodiments, the threshold value can be determined based on noise levels of first inspection image 501_1 and average image 510, defect detection sensitivity, etc.

While a second algorithm for detecting second type defects has been illustrated based on a comparison between first inspection image 501_1 and average image 510, it will be appreciated that any inspection image among the plurality of inspection images 501_1 to 501_N can be utilized to detect second type defects. According to a second algorithm, because average image 510 with less noise is utilized as a reference image, a nuisance rate can be reduced when detecting second type defects and thus defect detection accuracy can be improved.

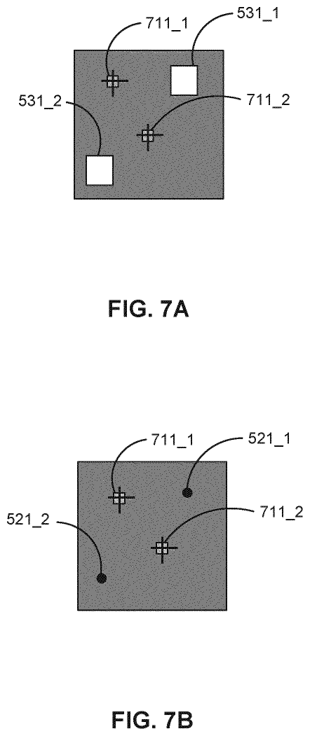

FIG. 7A illustrates a detected second type defect, consistent with embodiments of the present disclosure. In FIG. 7A, two second type defects 711_1 and 711_2 that are detected by second type defect detector 440 are shown. In some embodiments, second type defects 711_1 and 711_2 can be defects detected according to any of a first algorithm or a second algorithm. In some embodiments, when a plurality of pixels that are in close proximity to each other are determined to have pixel values exceeding a threshold value for determining a second type defect, it can be determined that the plurality of pixels can constitute a single second type defect. Accordingly, in some embodiments, a single second type defect (e.g., second type defect 711_1 or 711_2) can consist of multiple pixels. In some embodiments, second type defects 711_1 and 711_2 can refer to potential defects that may need a post process to remove nuisance defects, classify defects, etc.

Referring back to FIG. 4, defect combiner 450 can combine first type defect(s) detected by first type defect detector 420 and second type defect(s) detected by second type defect detector 440. FIG. 7B illustrates combined first and second type defects, consistent with embodiments of the present disclosure. In FIG. 7B, first type defects 521_1 and 521_2 and second type defects 711_1 and 711_2 are shown together at corresponding locations. While FIG. 7B illustrates detected first type defects and second type defects at corresponding locations on a frame, it will be appreciated that detected first type defects and second type defects can be combined to make a defect list including a defect identification, a defect location on an inspection image, a defect type, etc.

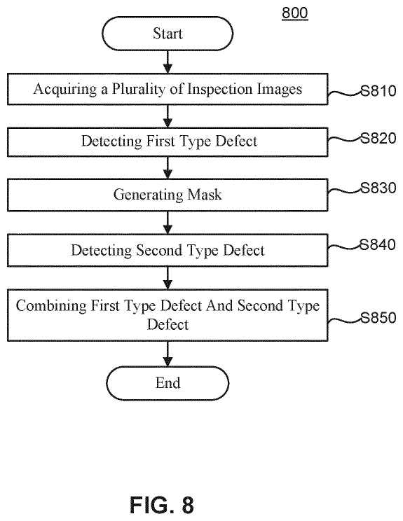

FIG. 8 is a process flowchart representing an exemplary transient defect detection method, consistent with embodiments of the present disclosure. The steps of method 800 can be performed by a system (e.g., system 400 of FIG. 4) executing on or otherwise using the features of a computing device, e.g., controller 109 of FIG. 1. It is appreciated that the illustrated method 800 can be altered to modify the order of steps and to include additional steps.

In step S810, a plurality of inspection images are acquired. Step S810 can be performed by, for example, inspection image acquirer 410, among others. In some embodiments, an inspection image is a SCPM image of a sample or a wafer. FIG. 5A illustrates a plurality of inspection images 501_1 to 501_N of a region of a wafer, e.g., a single image area or a die of the wafer. In some embodiments, the plurality of inspection images 501_1 to 501_N are taken over a certain time period. In some embodiments, the plurality of inspection images 501_1 to 501_N are taken over a time sequence.

In step S820, a first type defect can be detected. Step S820 can be performed by, for example, first type defect detector 410, among others. In some embodiments, first type defects from the plurality of inspection images 501_1 to 501_N acquired in step S810 can be detected. In some embodiments of the present disclosure, an average image of the plurality of inspection images 501_1 to 501_N can be obtained. FIG. 5B shows an average image 510 of the plurality of inspection images 501_1 to 501_N. In some embodiments, average image 510 can be obtained by averaging the plurality of inspection images 501_1 to 501_N per pixel. According to some embodiments of the present disclosure, first type defects can be detected by comparing average image 510 with a reference image. The process of detecting first type defects has been described with respect to FIG. 4, and thus the detailed explanation thereof will be omitted here for simplicity purposes.

In step S830, a mask is generated. Step S830 can be performed by, for example, mask generator 430, among others. In step S830, the mask (e.g., mask 530) including mask area(s) corresponding to first type defects detected in step S820 is generated. As shown in FIG. 5C, mask 530 can include mask areas corresponding to detected first type defects. In some embodiments, a location and a size of mask area 531_1 or 531_2 can be determined to cover a region containing a corresponding first type defect 521_1 or 521_2. In some embodiments, a size of mask area 531_1 or 531_2 can be determined to be larger than a size of first type defect 521_1 or 521_2 so to embrace boundaries of first type defect 521_1 or 521_2.

In step S840, a second type defect is detected. Step S840 can be performed by, for example, second type defect detector 440, among others. In step S840, second type defects from a plurality of inspection images acquired in step S810 can be detected. According to some embodiments of the present disclosure, the plurality of inspection images 501_1 to 501_N can be masked with the mask generated in step S830, and second type defects can be detected for non-masked areas of the plurality of inspection images 501_1 to 501_N.

According to some embodiments of the present disclosure, second type defect(s) can be detected by comparing the plurality of inspection images 501_1 to 501_N each other, which is illustrated as a first algorithm referring to FIG. 6A. According to some embodiments of the present disclosure, second type defects can be detected by comparing any individual masked inspection image from the plurality of inspection images 501_1 to 501_N with average image 510, which is illustrated as a second algorithm referring to FIG. 6B. The first algorithm and second algorithm have been described with respect to FIGS. 6A and 6B, and thus the detailed explanation thereof will be omitted here for simplicity purposes.

In step S850, a first type defect and a second type defect are combined. Step S850 can be performed by, for example, defect combiner 450, among others. In step S850, first type defect(s) detected in step S820 and second type defect(s) detected in step S840 are combined. FIG. 7B illustrates combined first and second type defects, consistent with embodiments of the present disclosure. In FIG. 7B, first type defects 521_1 and 521_2 and second type defects 711_1 and 711_2 are shown together at corresponding locations. While FIG. 7B illustrates detected first type defects and second type defects at corresponding locations on a frame, it will be appreciated that detected first type defects and second type defects can be combined to make a defect list including a defect identification, a defect location on an inspection image, a defect type, etc.

A non-transitory computer readable medium may be provided that stores instructions for a processor of a controller (e.g., controller 109 of FIG. 1) to carry out, among other things, image inspection, image acquisition, stage positioning, beam focusing, electric field adjustment, beam bending, condenser lens adjusting, activating charged-particle source, beam deflecting, and method 800. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:

1. A method of transient defect inspection using an inspection image, comprising:
acquiring a plurality of inspection images;
generating an average image of the plurality of inspection images;
detecting a first type defect in the average image;
determining a mask area corresponding to the first type defect; and
determining whether the plurality of inspection images have a second type defect in a non-masked area.
   2. The method of clause 1, wherein determining whether the plurality of inspection images have the second type defect comprises:
comparing a first inspection image of the plurality of inspection images to the average image for the non-masked area.
   3. The method of clause 2, wherein determining whether the plurality of inspection images have the second type defect further comprises:
generating a difference image between the first inspection image and the average image for the non-masked area; and determining whether the first inspection image has the second type defect based on the difference image.
   4. The method of clause 1, wherein determining whether the plurality of inspection images have the second type defect comprises:
masking the average image and a first inspection image of the plurality of inspection images for a region corresponding to the mask area; and
comparing the first inspection image of the plurality of inspection images to the average image for the non-masked area.
   5. The method of clause 1, wherein determining whether the plurality of inspection images have the second type defect comprises:
comparing a first inspection image of the plurality of inspection images to a second inspection image of the plurality of inspection images for the non-masked area.
   6. The method of clause 5, wherein determining whether the plurality of inspection images have the second type defect further comprises:
generating a difference image between the first inspection image and the second inspection image for the non-masked area; and
determining whether the plurality of inspection images have the second type defect based on the difference image.
   7. The method of clause 1, wherein determining whether the plurality of inspection images have the second type defect comprises:
masking a first inspection image and a second inspection image of the plurality of inspection images for a region corresponding to the mask area; and
comparing the first inspection image to the second inspection image for the non-masked area.
   8. The method of any one of clauses 1 to 7, further comprising:

combining the first type defect and the second type defect.

9. The method of any one of clauses 1 to 8, wherein determining the mask area corresponding to the first type defect comprises:
determining the mask area to cover a region containing the first type defect.
   10. A method of transient defect inspection using an inspection image, comprising:
acquiring a plurality of inspection images;
generating an average image of the plurality of inspection images;
detecting a first type defect in the average image;
determining a mask area corresponding to the first type defect;
comparing individual inspection images of the plurality of inspection images to the average image for a non-masked area; and
determining whether the plurality of inspection images have a second type defect in the non-masked area based on the comparison.
   11. The method of clause 10, wherein comparing individual inspection images of the plurality of inspection images to the average image comprises:
generating a difference image between a first inspection image of the plurality of inspection images and the average image for the non-masked area.
   12. The method of clause 11, wherein determining whether the plurality of inspection images have the second type defect comprises:
determining whether the first inspection image has the second type defect based on the difference image.
   13. The method of clause 10, wherein comparing individual inspection images of the plurality of inspection images to the average image comprises:
masking the average image and a first inspection image of the plurality of inspection images for a region corresponding to the mask area; and
comparing the first inspection image of the plurality of inspection images to the average image for the non-masked area.
   14. The method of any one of clauses 10 to 13, further comprising:
combining the first type defect and the second type defect.
   15. The method of any one of clauses 10 to 14, wherein determining the mask area corresponding to the first type defect comprises:
determining the mask area to cover a region containing the first type defect.
   16. An apparatus for transient defect inspection using an inspection image, comprising:
a memory storing a set of instructions; and
at least one processor configured to execute the set of instructions to cause the apparatus to perform:
acquiring a plurality of inspection images;
generating an average image of the plurality of inspection images;
detecting a first type defect in the average image;
determining a mask area corresponding to the first type defect; and
determining whether the plurality of inspection images have a second type defect in a non-masked area.
   17. The apparatus of clause 16, wherein, in determining whether the plurality of inspection images have the second type defect, the at least one processor is configured to execute the set of instructions to cause the apparatus to further perform:
comparing a first inspection image of the plurality of inspection images to the average image for the non-masked area.
   18. The apparatus of clause 17, wherein, in determining whether the plurality of inspection images have the second type defect, the at least one processor is configured to execute the set of instructions to cause the apparatus to further perform:
generating a difference image between the first inspection image and the average image for the non-masked area; and
determining whether the first inspection image has the second type defect based on the difference image.
   19. The apparatus of clause 16, wherein, in determining whether the plurality of inspection images have the second type defect, the at least one processor is configured to execute the set of instructions to cause the apparatus to perform:
masking the average image and a first inspection image of the plurality of inspection images for a region corresponding to the mask area; and
comparing the first inspection image of the plurality of inspection images to the average image for the non-masked area.
   20. The apparatus of clause 16, wherein, in determining whether the plurality of inspection images have the second type defect, the at least one processor is configured to execute the set of instructions to cause the apparatus to perform:
comparing a first inspection image of the plurality of inspection images to a second inspection image of the plurality of inspection images for the non-masked area.
   21. The apparatus of clause 20, wherein, in determining whether the plurality of inspection images have the second type defect, the at least one processor is configured to execute the set of instructions to cause the apparatus to further perform:
generating a difference image between the first inspection image and the second inspection image for the non-masked area; and
determining whether the plurality of inspection images have the second type defect based on the difference image.
   22. The apparatus of clause 16, wherein, in determining whether the plurality of inspection images have the second type defect, the at least one processor is configured to execute the set of instructions to cause the apparatus to perform:
masking a first inspection image and a second inspection image of the plurality of inspection images for a region corresponding to the mask area; and
comparing the first inspection image to the second inspection image for the non-masked area.
   23. The apparatus of any one of clauses 16 to 22, wherein the at least one processor is configured to execute the set of instructions to cause the apparatus to further perform:
combining the first type defect and the second type defect.
   24. The apparatus of any one of clauses 16 to 23, wherein, in determining the mask area corresponding to the first type defect, the at least one processor is configured to execute the set of instructions to cause the apparatus to perform:
determining the mask area to cover a region containing the first type defect.
   25. An apparatus for transient defect inspection using an inspection image, comprising:
a memory storing a set of instructions; and
at least one processor configured to execute the set of instructions to cause the apparatus to perform:
acquiring a plurality of inspection images;
generating an average image of the plurality of inspection images;
detecting a first type defect in the average image;
determining a mask area corresponding to the first type defect;
comparing individual inspection images of the plurality of inspection images to the average image for a non-masked area; and
determining whether the plurality of inspection images have a second type defect in the non-masked area based on the comparison.
   26. The apparatus of clause 25, wherein, in comparing individual inspection images of the plurality of inspection images to the average image, the at least one processor is configured to execute the set of instructions to cause the apparatus to perform:
generating a difference image between a first inspection image of the plurality of inspection images and the average image for the non-masked area.
   27. The apparatus of clause 26, wherein, in determining whether the plurality of inspection images have the second type defect, the at least one processor is configured to execute the set of instructions to cause the apparatus to perform:
determining whether the first inspection image has the second type defect based on the difference image.
   28. The apparatus of clause 25, wherein, in comparing individual inspection images of the plurality of inspection images to the average image, the at least one processor is configured to execute the set of instructions to cause the apparatus to perform:
masking the average image and a first inspection image of the plurality of inspection images for a region corresponding to the mask area; and
comparing the first inspection image of the plurality of inspection images to the average image for the non-masked area.
   29. The apparatus of any one of clauses 25 to 28, wherein the at least one processor is configured to execute the set of instructions to cause the apparatus to further perform:
combining the first type defect and the second type defect.
   30. The apparatus of any one of clauses 25 to 29, wherein, in determining the mask area corresponding to the first type defect, the at least one processor is configured to execute the set of instructions to cause the apparatus to perform:
determining the mask area to cover a region containing the first type defect.
   31. A non-transitory computer readable medium that stores a set of instructions that is executable by at least on processor of a computing device to cause the computing device to perform a method of transient defect inspection using an inspection image, the method comprising:
acquiring a plurality of inspection images;
generating an average image of the plurality of inspection images;
detecting a first type defect in the average image;
determining a mask area corresponding to the first type defect; and
determining whether the plurality of inspection images have a second type defect in a non-masked area.
   32. The computer readable medium of clause 31, wherein, in determining whether the plurality of inspection images have the second type defect, the set of instructions that is executable by at least one processor of the computing device cause the computing device to perform:
comparing a first inspection image of the plurality of inspection images to the average image for the non-masked area.
   33. The computer readable medium of clause 32, wherein, in determining whether the plurality of inspection images have the second type defect, the set of instructions that is executable by at least one processor of the computing device cause the computing device to further perform:
generating a difference image between the first inspection image and the average image for the non-masked area; and
determining whether the first inspection image has the second type defect based on the difference image.
   34. The computer readable medium of clause 31, wherein, in determining whether the plurality of inspection images have the second type defect, the set of instructions that is executable by at least one processor of the computing device cause the computing device to perform:
masking the average image and a first inspection image of the plurality of inspection images for a region corresponding to the mask area; and
comparing the first inspection image of the plurality of inspection images to the average image for the non-masked area.
   35. The computer readable medium of clause 31, wherein, in determining whether the plurality of inspection images have the second type defect, the set of instructions that is executable by at least one processor of the computing device cause the computing device to perform:
comparing a first inspection image of the plurality of inspection images to a second inspection image of the plurality of inspection images for the non-masked area.
   36. The computer readable medium of clause 35, wherein, in determining whether the plurality of inspection images have the second type defect, the set of instructions that is executable by at least one processor of the computing device cause the computing device to further perform:
generating a difference image between the first inspection image and the second inspection image for the non-masked area; and
determining whether the plurality of inspection images have the second type defect based on the difference image.
   37. The computer readable medium of clause 31, wherein, in determining whether the plurality of inspection images have the second type defect, the set of instructions that is executable by at least one processor of the computing device cause the computing device to perform:
masking a first inspection image and a second inspection image of the plurality of inspection images for a region corresponding to the mask area; and
comparing the first inspection image to the second inspection image for the non-masked area.
   38. The computer readable medium of any one of clauses 31 to 37, wherein the set of instructions that is executable by at least one processor of the computing device cause the computing device to further perform:
combining the first type defect and the second type defect.
   39. The computer readable medium of any one of clauses 31 to 38, wherein, in determining the mask area corresponding to the first type defect, the set of instructions that is executable by at least one processor of the computing device cause the computing device to perform:
determining the mask area to cover a region containing the first type defect.
   40. A non-transitory computer readable medium that stores a set of instructions that is executable by at least on processor of a computing device to cause the computing device to perform a method of transient defect inspection using an inspection image, the method comprising:
acquiring a plurality of inspection images;
generating an average image of the plurality of inspection images;
detecting a first type defect in the average image;
determining a mask area corresponding to the first type defect;
comparing individual inspection images of the plurality of inspection images to the average image for a non-masked area; and
determining whether the plurality of inspection images have a second type defect in the non-masked area based on the comparison.
   41. The computer readable medium of clause 40, wherein, in comparing individual inspection images of the plurality of inspection images to the average image, the set of instructions that is executable by at least one processor of the computing device cause the computing device to perform:
generating a difference image between a first inspection image of the plurality of inspection images and the average image for the non-masked area.
   42. The computer readable medium of clause 41, wherein, in determining whether the plurality of inspection images have the second type defect, the set of instructions that is executable by at least one processor of the computing device cause the computing device to perform:
determining whether the first inspection image has the second type defect based on the difference image.
   43. The computer readable medium of clause 40, wherein, in comparing individual inspection images of the plurality of inspection images to the average image, the set of instructions that is executable by at least one processor of the computing device cause the computing device to perform:
masking the average image and a first inspection image of the plurality of inspection images for a region corresponding to the mask area; and
comparing the first inspection image of the plurality of inspection images to the average image for the non-masked area.
   44. The computer readable medium of any one of clauses 40 to 43, wherein the set of instructions that is executable by at least one processor of the computing device cause the computing device to further perform:
combining the first type defect and the second type defect.
   45. The computer readable medium of any one of clause 40 to 44, wherein, in determining the mask area corresponding to the first type defect, the set of instructions that is executable by at least one processor of the computing device cause the computing device to perform:
determining the mask area to cover a region containing the first type defect.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that comprises one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus for transient defect inspection using an inspection image, comprising:
a memory storing a set of instructions; and
at least one processor configured to execute the set of instructions to cause the apparatus to perform:
acquiring a plurality of inspection images;
generating an average image of the plurality of inspection images;
detecting a first type defect in the average image;
determining a mask area corresponding to the first type defect; and
determining whether the plurality of inspection images have a second type defect in a non-masked area.

2. The apparatus of claim 1, wherein, in determining whether the plurality of inspection images have the second type defect, the at least one processor is configured to execute the set of instructions to cause the apparatus to further perform:
comparing a first inspection image of the plurality of inspection images to the average image for the non-masked area.

3. The apparatus of claim 2, wherein, in determining whether the plurality of inspection images have the second type defect, the at least one processor is configured to execute the set of instructions to cause the apparatus to further perform:
generating a difference image between the first inspection image and the average image for the non-masked area; and
determining whether the first inspection image has the second type defect based on the difference image.

4. The apparatus of claim 1, wherein, in determining whether the plurality of inspection images have the second type defect, the at least one processor is configured to execute the set of instructions to cause the apparatus to perform:
masking the average image and a first inspection image of the plurality of inspection images for a region corresponding to the mask area; and
comparing the first inspection image of the plurality of inspection images to the average image for the non-masked area.

5. The apparatus of claim 1, wherein, in determining whether the plurality of inspection images have the second type defect, the at least one processor is configured to execute the set of instructions to cause the apparatus to perform:
comparing a first inspection image of the plurality of inspection images to a second inspection image of the plurality of inspection images for the non-masked area.

6. The apparatus of claim 5, wherein, in determining whether the plurality of inspection images have the second type defect, the at least one processor is configured to execute the set of instructions to cause the apparatus to further perform:
generating a difference image between the first inspection image and the second inspection image for the non-masked area; and
determining whether the plurality of inspection images have the second type defect based on the difference image.

7. The apparatus of claim 1, wherein, in determining whether the plurality of inspection images have the second type defect, the at least one processor is configured to execute the set of instructions to cause the apparatus to perform:
masking a first inspection image and a second inspection image of the plurality of inspection images for a region corresponding to the mask area; and
comparing the first inspection image to the second inspection image for the non-masked area.

8. The apparatus of claim 1, wherein the at least one processor is configured to execute the set of instructions to cause the apparatus to further perform:
combining the first type defect and the second type defect.

9. The apparatus of claim 1, wherein, in determining the mask area corresponding to the first type defect, the at least one processor is configured to execute the set of instructions to cause the apparatus to perform:
determining the mask area to cover a region containing the first type defect.

10. An apparatus for transient defect inspection using an inspection image, comprising:
a memory storing a set of instructions; and
at least one processor configured to execute the set of instructions to cause the apparatus to perform:
acquiring a plurality of inspection images;
generating an average image of the plurality of inspection images;
detecting a first type defect in the average image;
determining a mask area corresponding to the first type defect;
comparing individual inspection images of the plurality of inspection images to the average image for a non-masked area; and
determining whether the plurality of inspection images have a second type defect in the non-masked area based on the comparison.

11. The apparatus of claim 10, wherein, in comparing individual inspection images of the plurality of inspection images to the average image, the at least one processor is configured to execute the set of instructions to cause the apparatus to perform:
generating a difference image between a first inspection image of the plurality of inspection images and the average image for the non-masked area.

12. The apparatus of claim 11, wherein, in determining whether the plurality of inspection images have the second type defect, the at least one processor is configured to execute the set of instructions to cause the apparatus to perform:
determining whether the first inspection image has the second type defect based on the difference image.

13. The apparatus of claim 10, wherein, in comparing individual inspection images of the plurality of inspection images to the average image, the at least one processor is configured to execute the set of instructions to cause the apparatus to perform:
masking the average image and a first inspection image of the plurality of inspection images for a region corresponding to the mask area; and
comparing the first inspection image of the plurality of inspection images to the average image for the non-masked area.

14. The apparatus of claim 10, wherein the at least one processor is configured to execute the set of instructions to cause the apparatus to further perform:
combining the first type defect and the second type defect.

15. The apparatus of claim 10, wherein, in determining the mask area corresponding to the first type defect, the at least one processor is configured to execute the set of instructions to cause the apparatus to perform:
determining the mask area to cover a region containing the first type defect.

16. A non-transitory computer readable medium that stores a set of instructions that is executable by at least on processor of a computing device to cause the computing device to perform operations for transient defect inspection using an inspection image, the operations comprising:
acquiring a plurality of inspection images;
generating an average image of the plurality of inspection images;
detecting a first type defect in the average image;
determining a mask area corresponding to the first type defect; and
determining whether the plurality of inspection images have a second type defect in a non-masked area.

17. The computer readable medium of claim 16, wherein, in determining whether the plurality of inspection images have the second type defect, the set of instructions that is executable by at least one processor of the computing device cause the computing device to perform operations comprising:
comparing a first inspection image of the plurality of inspection images to the average image for the non-masked area.

18. The computer readable medium of claim 17, wherein, in determining whether the plurality of inspection images have the second type defect, the set of instructions that is executable by at least one processor of the computing device cause the computing device to further perform operations comprising:
generating a difference image between the first inspection image and the average image for the non-masked area; and
determining whether the first inspection image has the second type defect based on the difference image.

19. The computer readable medium of claim 16, wherein, in determining whether the plurality of inspection images have the second type defect, the set of instructions that is executable by at least one processor of the computing device cause the computing device to perform operations comprising:
masking the average image and a first inspection image of the plurality of inspection images for a region corresponding to the mask area; and
comparing the first inspection image of the plurality of inspection images to the average image for the non-masked area.

20. The computer readable medium of claim 16, wherein, in determining whether the plurality of inspection images have the second type defect, the set of instructions that is executable by at least one processor of the computing device cause the computing device to perform operations comprising:
comparing a first inspection image of the plurality of inspection images to a second inspection image of the plurality of inspection images for the non-masked area.
